(19) United States
(12) Patent Application Publication
(10) Pub. No.: US 2013/0185315 A1
(43) Pub. Date: Jul. 18, 2013

(54) Identification of Events of Interest

(71) Applicants: Ming C. Hao, Palo Alto, CA (US); Umeshwar Dayal, Saratoga, CA (US); Christian Rohrdantz, Konstanz (DE)

(72) Inventors: Ming C. Hao, Palo Alto, CA (US); Umeshwar Dayal, Saratoga, CA (US); Christian Rohrdantz, Konstanz (DE)

(21) Appl. No.: 13/823,228

(22) PCT Filed: Sep. 30, 2010
(86) PCT No.: PCT/US10/50928

§ 371 Date: Mar. 14, 2013

(51) Int. Cl. G06F 17/30

(52) U.S. Cl. CPC G06F 17/3053
USPC 707/751

(57) ABSTRACT

Example embodiments relate to identification of events of interest from a feed including a plurality of events. Example embodiments may determine an interestingness score for each of a plurality of time intervals, each time interval including one or more events from the feed of events. Example embodiments may then select a time interval or output a visualization of the time interval, where the score of the time interval indicates that the time interval is likely to contain events of interest.

### BACKGROUND

With the rapid growth of computer technologies and a corresponding increase in the usage of the Internet, there is now a wealth of valuable information available to corporations, small business owners, website operators, and other entities interested in obtaining customer feedback and other market data. For example, many web users submit reviews, complaints, and other feedback regarding a company and its products and services using blogs, social networking sites, review sites, and numerous other online services.

This information is valuable to a company or other entity in improving its products and services, addressing customer complaints, and otherwise harnessing feedback to increase sales and customer satisfaction. Given the sheer amount of information available, however, it is often difficult for a company or other entity to separate useful feedback or data from the remainder of the information.

### BRIEF DESCRIPTION OF THE DRAWINGS

The following detailed description references the drawings, wherein:

FIG. 1 is a block diagram of an example computing device for identifying, from a feed of events, a time interval likely to contain events of interest;

FIG. 2 is a block diagram of an example computing device for identifying and visualizing, from a feed of events, a time interval likely to contain events of interest;

FIG. 3 is a flowchart of an example method for identifying a time interval likely to contain events of interest;

FIG. 4A is a flowchart of an example method for grouping a plurality of events in a feed of events into a plurality of candidate time intervals;

FIG. 4B is a flowchart of an example method for calculating a score for each of a plurality of candidate time intervals;

FIG. 4C is a flowchart of an example method for outputting a visualization of a plurality of events and a time interval likely to contain events of interest; and

FIG. 5 is an example visualization of a plurality of events and a time interval likely to contain events of interest.

### DETAILED DESCRIPTION

As detailed above, a company or other entity may desire to extract useful feedback or other data from a data source, such as a social networking site, news feed, user review website, local database, or similar source of information. For example, in some situations, the entity may wish to analyze a data stream over a duration of time to identify periods of increased negative activity, thereby isolating common problems or other anomalies. In this manner, the entity may quickly identify and respond to problems in a manner that minimizes customer dissatisfaction, monetary loss, and other damage to the entity. Conversely, the entity may desire to identify periods of increased positive activity to ensure that the entity properly capitalizes on an opportunity and maintains customer loyalty. Given the massive amount of information available, however, it may be difficult for the entity and its analysts to accurately isolate these interesting events in a time and cost efficient manner.

To address to this issue, example embodiments disclosed herein allow for automatic identification of events of interest from a feed of events. For example, in some embodiments, a computing device may group a plurality of events from a feed of events into a number of time intervals based on a time associated with each event. The computing device may then calculate a score for each time interval and select a particular time interval with a score indicating that the time interval is likely to contain events of interest. In some embodiments, the score for each time interval may be based on an interestingness of each event in the time interval, a density of interesting events in the time interval, and a smoothness of interesting events in the time interval. In addition, in some embodiments, the computing device may output a visualization identifying a plurality of events and the time interval likely to contain events of interest.

In this manner, example embodiments analyze a feed of events to automatically identify one or more periods of time that are likely to contain events of interest in a reliable, time efficient manner. Example embodiments thereby reduce costs and minimize the time required for an analyst to accurately isolate events of interest from a feed of events. Additional embodiments and applications of such embodiments will be apparent to those of skill in the art upon reading and understanding the following description.

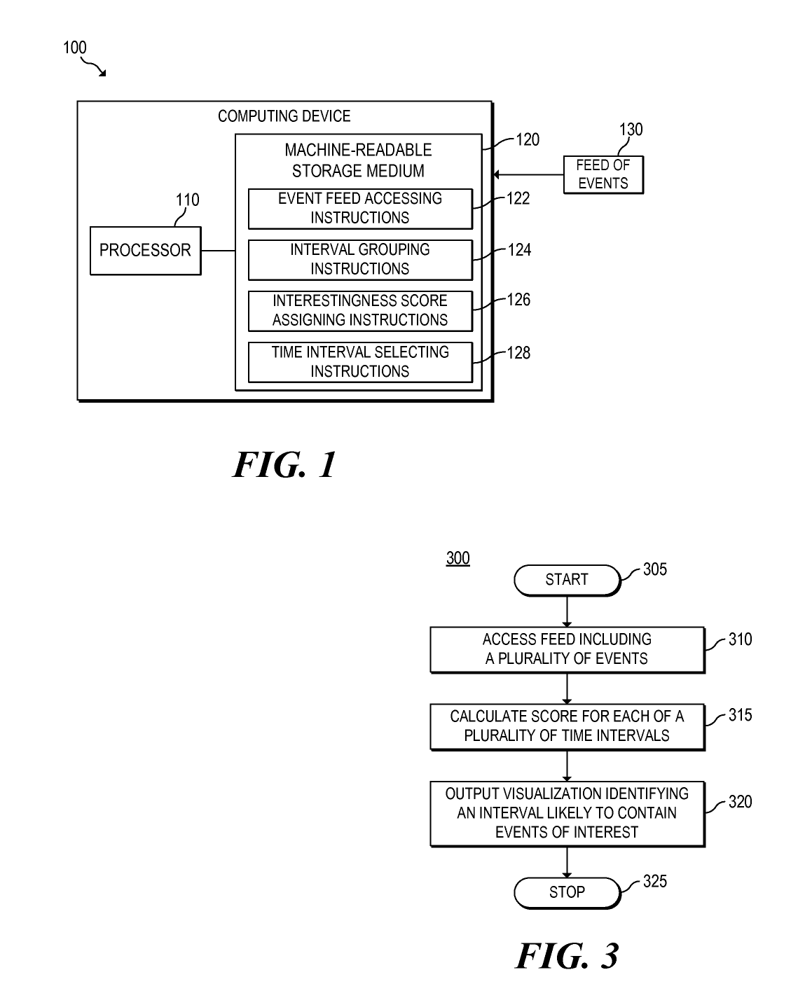

Referring now to the drawings, FIG. 1 is a block diagram of an example computing device 100 for identifying, from a feed of events 130, a time interval likely to contain events of interest. Computing device 100 may be, for example, a workstation, a server, a notebook computer, a desktop computer, an all-in-one system, a slate computing device, or any other computing device suitable for execution of the functionality described below. In the embodiment of FIG. 1, computing device 100 includes processor 110 and machine-readable storage medium 120.

Processor 110 may be one or more central processing units (CPUs), semiconductor-based microprocessors, and/or other hardware devices suitable for retrieval and execution of instructions stored in machine-readable storage medium 120. Processor 110 may fetch, decode, and execute instructions 122, 124, 126, 128 to implement the time interval identification procedure described in detail below. As an alternative or in addition to retrieving and executing instructions, processor 110 may include one or more integrated circuits (ICs) or other electronic circuits that include a number of electronic components for performing the functionality of one or more of instructions 122, 124, 126, 128.

Machine-readable storage medium 120 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read-Only Memory (CD-ROM), and the like. As described in detail below, machine-readable storage medium 120 may be encoded with instructions executable by processor 110 to identify a time interval likely to contain events of interest.

Machine-readable storage medium 120 may include event feed accessing instructions 122, which may access a feed of events 130 including a plurality of events, each of which is associated with a time and a score. Accessing instructions 122 may be initially triggered upon receipt of a command from a user of computing device 100 to identify one or more intervals of time that are likely to contain events of interest. For example, the user of computing device 100 may desire to analyze feed of events 130 to isolate periods of increased positive or negative activity in feed of events 130. Based on receipt of such a command, accessing instructions 122 may access the feed from a storage device locally accessible to computing device 100, from a web or network accessible storage location or server, or from any other location or locations.

Feed of events 130 may be any source of information that includes a number of separate events from a data stream, such as a Really Simple Syndication (RSS) feed or a similar stream of information. To name a few examples, feed of events 130 may be a collection of items posted to a social networking site, an online review site, a blog, an online store, a message board, a news website, or any other collection of information. In some embodiments, the feed of events 130 may itself include items from a combination of feeds, which accessing instructions 122 may access individually or through a central source that aggregates the feeds.

Each event in feed of events 130 may be an unstructured data item corresponding to the particular type of feed. For example, each event may be an unstructured data item that includes raw text data. It should be noted, however, that although the particular item to be analyzed may be unstructured (e.g., raw text data), the item itself may be packaged or otherwise included in some structure (e.g., an HTML document, an XML document, a file of a predefined format, a database entry, etc.).

To give a specific example, when feed of events 130 is a collection of social networking items, each event may be a status update or any other item that may be posted to a social networking site. When feed of events 130 is a website with a user review capability, each event may be a user-submitted review of a particular product or service. Other examples of events will be apparent to those of skill in the art based on the particular type of feed 130.

As mentioned above, each event may be associated with a time and a score. The time associated with an event may be a time at which the event was submitted or posted, a time corresponding to an occurrence described by the event (e.g., a time of purchase of a product to which a review relates), or any other time related to the underlying event. The score associated with an event may be any numeric or other value that describes some property of the event. Thus, the score may be, for example, a score in a range of numbers (e.g., 0.0 to 10.0, 1 to 5 stars, etc.), a value representing approval (e.g., thumbs up or thumbs down), or another value that represents an opinion regarding the subject matter of the event.

It should be noted that, in some embodiments, the score may be derived based on text or other data included in the event. In such embodiments, accessing instructions 122 or another set of instructions may determine a score for the event even though the event itself does not include a score. For example, accessing instructions 122 may assign a score based on the occurrence of keywords from a set of positive attributes (e.g., good, great, like, love, etc.) and the occurrence of a keywords from a set of negative attributes (e.g., bad, disappointing, dislike, etc.). In some embodiments, rather than performing analysis of the event, a user of computing device 100 may manually assign a score by reading and analyzing the particular event.

Regardless of the particular format, each score may be used to determine whether an event is considered to be interesting or uninteresting based on satisfaction of a predetermined condition or conditions. For example, a particular range or set of scores may be considered interesting, while another range or set scores may be considered uninteresting. As described below in connection with interestingness score assigning instructions 126, the interestingness of each event may be used in assigning a score to each of a plurality of time intervals including a number of events.

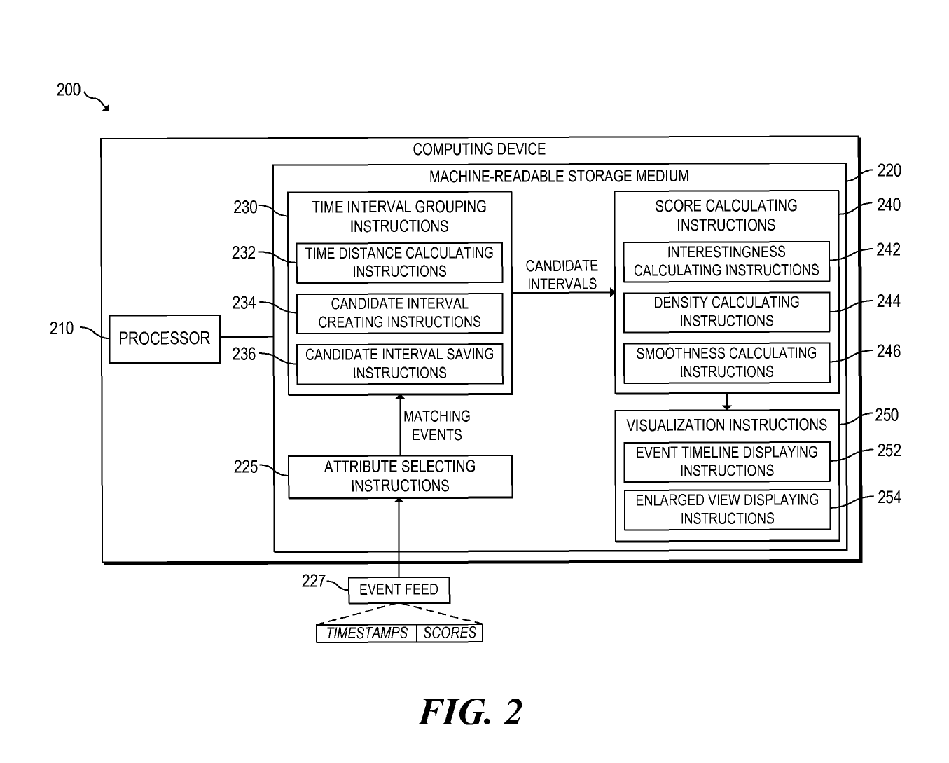

In some embodiments, accessing instructions 122 may access the feed of events 130 and forward the entire feed to interval grouping instructions 124 for further processing, as described below. Alternatively, accessing instructions 122 may first filter feed of events 130 to select events associated with a predetermined set of keywords. For example, accessing instructions 122 may receive a list of one or more keywords identifying subject matter of interest from a user of computing device 100. In response, accessing instructions 122 may select all events in feed of events 130 that include a keyword contained in the list of keywords. Additional details of an example process for filtering feed of events 130 are provided below in connection with attribute selecting instructions 225 of FIG. 2.

After event feed accessing instructions 122 access and filter the feed of events 130, interval grouping instructions 124 may group the events into a plurality of time intervals based on the time associated with each event. For example, when the feed of events 130 is in chronological order, interval grouping instructions 124 may first determine a time distance (i.e., length of time) between each adjacent pair of events. Interval grouping instructions 124 may then group the events into a number of intervals for which the time distances between events in the interval are relatively small. In other words, grouping instructions 124 may identify intervals for which events occur with a high time density.

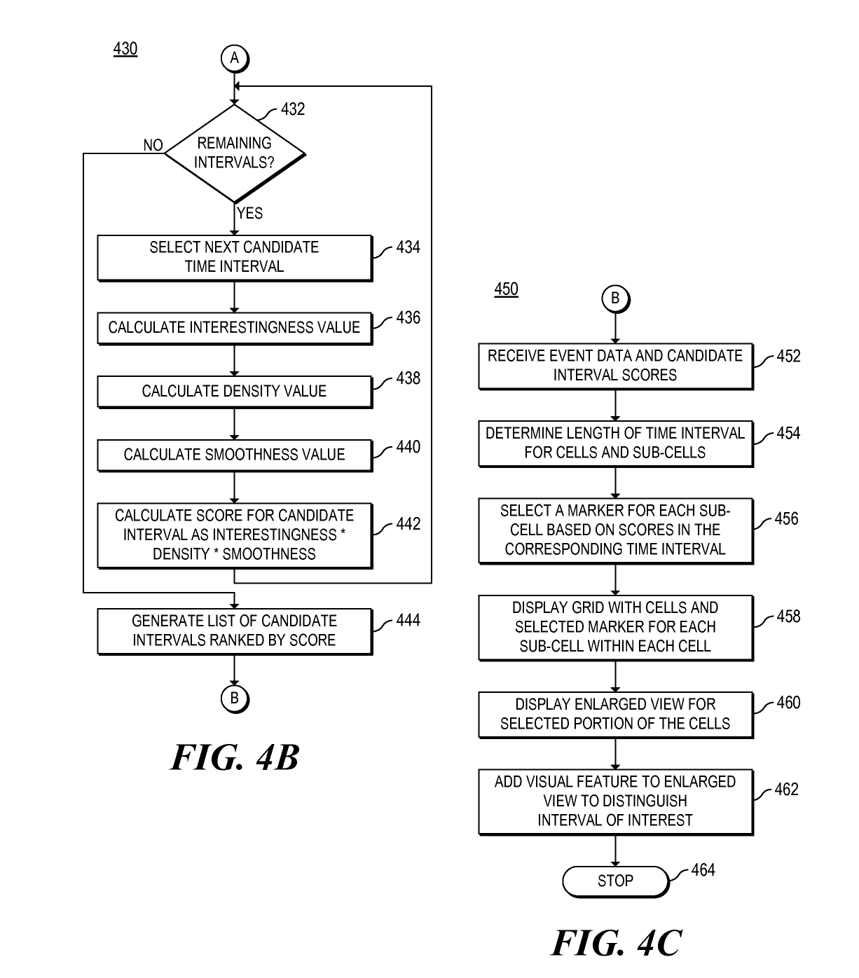

In some embodiments, in identifying these intervals, grouping instructions 124 may first determine an average of all of the determined time distances. Grouping instructions 124 may then traverse the time distances in order and, during the traversal, identify pairs of events for which the time distance is less than the average. Grouping instructions 124 may then add each time distance and the corresponding events to an interval as long as the time distance is less than average. After reaching a time distance that is greater than or equal to the average, grouping instructions 124 may save the interval and the events contained therein as a candidate time interval. Grouping instructions 124 may continue this procedure until reaching the last time distance, thereby creating a number of candidate time intervals for which events occur with a high time density. Additional details regarding an example procedure for grouping items into candidate time intervals are provided below in connection with FIG. 4A.

In some embodiments, prior to saving a candidate time interval for further analysis, grouping instructions 124 may examine the scores of the events in the interval to determine whether there is a greater proportion of interesting scores than uninteresting scores. For example, when the user originally requested that computing device 100 identify periods of increased negative activity, grouping instructions 124 may only save the candidate interval when there are more negative scores than positive scores in each candidate interval. Conversely, when the user originally requested that computing device 100 identify periods of increased positive activity, grouping instructions 124 may only save the candidate interval when there are more positive scores. Grouping instructions 124 may similarly save candidate intervals based on other conditions defining whether an event is interesting.

After grouping instructions 124 generate a number of candidate intervals, interestingness score assigning instructions 126 may assign an interestingness score to each time interval based at least on the score of each event in the interval. The determined interestingness score for a particular interval may represent the likelihood that the particular interval includes events that are of interest to the user of computing device 100.

In some embodiments, the interestingness score for a particular interval of time may be based on a number of factors including an interestingness value, a density value, and a smoothness value. For example, the interestingness score may be the product of the interestingness value, the density value, and the smoothness value, as defined by the following equation, where X is a candidate interval:

score(X)=density(X)·negativity(X)·smoothness(X) [Equation 1]

In such embodiments, the interestingness value may represent the total number or proportion of interesting events in the particular time interval. As detailed above, an event may be considered interesting when the score of the event satisfies a predetermined condition. For example, the condition may specify a range or set of scores for which a particular event is considered to be a positive event. Alternatively, the condition may specify a range or set of scores for which a particular event is considered to be a negative event.

The interestingness value may be, for example, a number of interesting events during the interval divided by a total number of events during the interval. As another example, the interestingness value may be a total number of interesting (e.g., positive or negative) events during the interval. As a specific example, the following equation defines an example interestingness value based on a total number of negative scores, where X is a time interval, x is a particular event in the time interval, and V(x) is the score of a particular event, x:

interestingness(X)=|{xεX:V(x)<0}| [Equation 2]

In addition to the interestingness value, the interestingness score may also consider a density value, which may represent a compactness of interesting events in the time interval. The time density of interesting events may be considered in determining the interestingness score since events are of a higher time density during a period of increased activity.

In general, the smaller the relative time distances among the events x within an interval X, the higher the density value of the interval X. Thus, in some embodiments, the density value for a particular time interval may be the product of a determined time density and, to compensate for the undesired influence of uninteresting events, the fraction of uninteresting events in the time interval. The time density used in this calculation may be proportionate to the average time distance in the interval. As a specific example, the following equation defines an example time density value assuming that an interesting score is of a negative value, where X is a time interval, x is a particular event in the time interval, avg(D) is the average of all time distances for the selected events in feed of events 130, D(xᵢ) is the time distance from an event xᵢ to a succeeding event, xᵢ₊₁, and V(x) is the score of a particular event:

$$density ( X ) = [ \frac{1}{\vert \{ x ∈ X \} \vert} {\sum }_{x ∈ X}^{ } ( 1 - \frac{D ( x )}{avg ( D )} ) ] \cdot ( 1 - \frac{\vert \{ x ∈ X : V ( x ) > 0 \} \vert}{\vert \{ x ∈ X \} \vert} ) \qquad [ Equation 3 ]$$

Finally, as a third component of the interestingness score of a particular time interval, instructions 126 may determine a smoothness value, which may represent the regularity of interesting events over the time interval. A smoothness of events may be considered in determining the interestingness score since the time density of related events in time generally shows an increase in frequency, reaches a plateau, and subsequently shows a decrease in frequency.

In general, the smaller the average normalized difference of succeeding time distances within an interval X, the higher the smoothness value of the interval X. Accordingly, in some embodiments, the smoothness value for a particular time interval may be the standard deviation of time differences among pairs of consecutive time distance values. As a specific example, the following equation defines an example smoothness value, where X is a time interval, x is a particular event in the time interval, avg(D) is the average of all time distances for the selected events in feed of events 130, and D(xᵢ) is the time distance from an event xᵢ to a succeeding event, xᵢ₊₁:

$$smoothness ( X ) = 1 - [ \frac{1}{\vert x ∈ X \vert - 1} {\sum }_{i = 0}^{i < ( \vert x ∈ X \vert - 1 )} \vert \frac{D ( {x}_{i} )}{avg ( D )} - \frac{D ( {x}_{i + 1} )}{avg ( D )} \vert ] \qquad [ Equation 4 ]$$

After calculation of an interestingness score for each time interval, time interval selecting instructions 128 may select a particular time interval with an interestingness score indicating that the particular time interval is likely to contain events of interest. For example, when the interestingness score for each interval is a product of the interestingness value, the density value, and the smoothness value, selecting instructions 128 may select the particular time interval with the largest interestingness score as the interval likely to contain events of interest. Selecting instructions 128 may, in some embodiments, identify multiple intervals that are likely to contain events of interest based, for example, on the n highest interestingness scores.

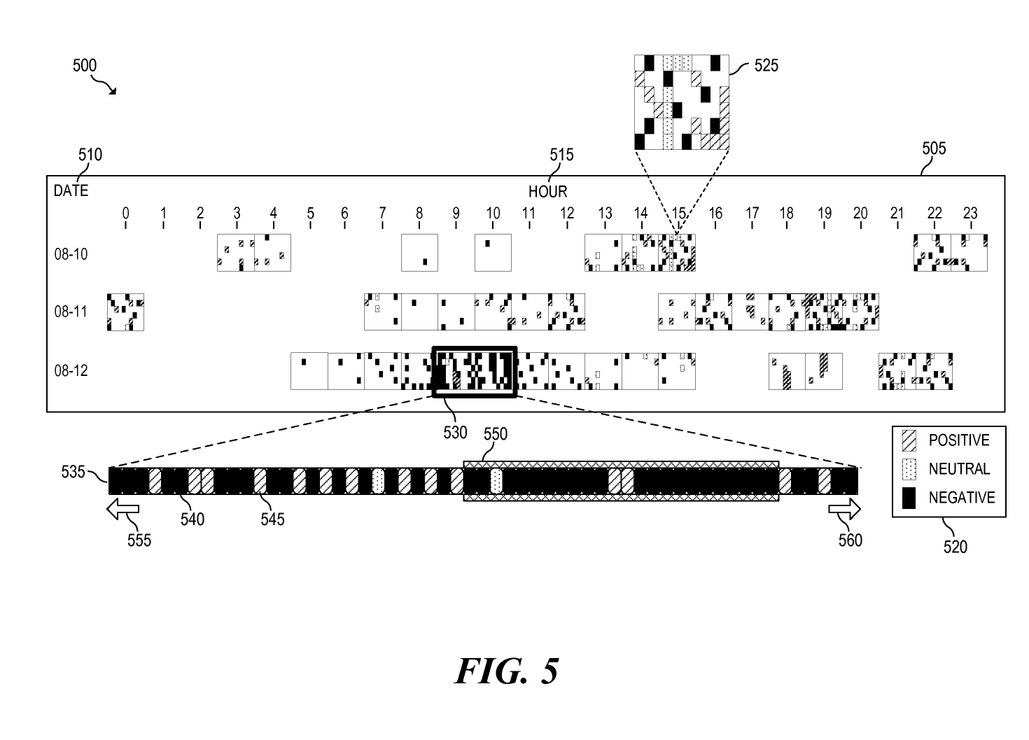

After selection of the interval or intervals likely to contain events of interest, instructions 128 may, for example, identify the intervals to the user of computing device 100. For example, instructions 128 may output a visualization illustrating a plurality of events and identifying the particular time intervals selected as likely to include events of interest. Additional details regarding an example visualization are provided in connection with visualization instructions 250 of FIG. 2 and visualization 500 of FIG. 5.

FIG. 2 is a block diagram of an example computing device 200 for identifying and visualizing, from a feed of events 227, a time interval likely to contain events of interest. As with computing device 100 of FIG. 1, computing device 200 may be, for example, a workstation, a server, a notebook computer, a desktop computer, an all-in-one system, a slate computing device, or any other computing device suitable for execution of the functionality described below, in the embodiment of FIG. 2, computing device 200 includes processor 210 and machine-readable storage medium 220.

As with processor 110, processor 210 may be a CPU or microprocessor suitable for retrieval and execution of instructions and/or one or more electronic circuits configured to perform the functionality of one or more of instructions 225, 230, 240, 250 described below. Machine-readable storage medium 220 may be any electronic, magnetic, optical, or other physical storage device that contains or stores executable instructions. As described in detail below, machine-readable storage medium 220 may be encoded with executable instructions for identifying a time interval likely to contain events of interest.

Machine-readable storage medium 220 may include attribute selecting instructions 225, which may access an event feed 227 including a number of events, each associated with a time and a score. As with feed of events 130 of FIG. 1, event feed 227 may be any source of information that includes a number of separate events, while each event may be a data item corresponding to the particular type of feed. Selecting instructions 225 may access event feed 227 from a storage device locally accessible to computing device 200, from a web or network accessible storage location or server, or from any other location or locations.

After accessing event feed 227, attribute selecting instructions 225 may select a plurality of events from feed 227 based on occurrence of a predetermined attribute or attributes in each event. An attribute may be any string of alphanumeric characters that identify a property to be matched when selecting a subset of matching events from event feed 227. Thus, as an example, the attribute may be a keyword provided by a user of computing device 200 to identify the subject matter for which the user desires to isolate periods of increased activity. Upon receipt of one or more attributes, selecting instructions 225 may examine the text associated with each event and only select events that include one or more of the provided attributes.

As a specific example, suppose an analyst wishes to detect significant periods of interest regarding a particular product sold by the analyst's company. In this case, the analyst may provide computing device 200 with one or more keywords identifying the product, such as a model number or model name. Based on receipt of the keywords, selecting instructions 225 may then access event feed 227 and provide time interval grouping instructions 230 with only events that match at least one of the provided keywords.

Time interval grouping instructions 230 may include a series of instructions for grouping a plurality of events from event feed 227 into a plurality of time intervals based on a time associated with each event. For example, time interval grouping instructions 230 may include time distance calculating instructions 232, which may calculate a plurality of time distances, each representing an elapsed time between a pair of consecutive events. For example, calculating instructions 232 may traverse a list of chronological events, select one pair of adjacent events at a time, and calculate a time distance for each pair. In this manner, calculating instructions 232 may obtain a list of n−1 time distances for a list of n events. Calculating instructions 232 may then compute an average of the n−1 time distances, which may be used in creating candidate time intervals.

Grouping instructions 230 may also include candidate interval creating instructions 234, which may create a candidate time interval and add a plurality of time distances to a given candidate interval while each consecutive time distance is less than the average time distance. In other words, after creating a new candidate interval, creating instructions 234 may, for each consecutive time distance less than the average, add the time distance and the corresponding pair of events to the candidate interval.

Finally, grouping instructions 230 may include candidate interval saving instructions 236, which may save a created candidate interval when the candidate interval includes more interesting events than uninteresting events. For example, saving instructions 236 may determine a total number of interesting and uninteresting events in the interval based on the score of each event and a predetermined condition specifying whether an event is interesting based on its score. When the number of interesting events exceeds the number of uninteresting events, saving instructions 236 may save the candidate interval for further processing and may otherwise discard the interval.

Score calculating instructions 240 may calculate a score for each saved candidate time interval and select one or more time intervals with scores indicating that each time interval is likely to contain events of interest. In some embodiments, this score may be based on an interestingness of each event in the time interval, a density of interesting events in the time interval, and a smoothness of interesting events in the time interval. For example, score calculating instructions 240 may calculate the score for each time interval as a product of a three values, each of which is determined by one of instructions 242, 244, 246, and select the time interval for which the determined product is the largest.

Score calculating instructions 240 may include interestingness calculating instructions 242, which may determine an interestingness value as a total number of interesting events in the time interval. Additional details regarding an example calculation of the interestingness value are provided above in connection with interestingness score assigning instructions 126 of FIG. 1 and Equation 2.

Score calculating instructions 240 may also include density calculating instructions 244, which may calculate a density value as a product of a time density of events in the interval and a fraction of uninteresting events in the time interval. Additional details regarding an example calculation of the density value are provided above in connection with interestingness score assigning instructions 126 of FIG. 1 and Equation 3.

Finally, score calculating instructions 240 may include smoothness calculating instructions 246, which may calculate a smoothness value as a standard deviation of time differences among pairs of consecutive time distance values in the interval. Additional details regarding an example calculation of the smoothness value are provided above in connection with interestingness score assigning instructions 126 of FIG. 1 and Equation 4.

After calculating instructions 240 calculate a score for each interval and identify one or more intervals likely to contain events of interest, visualization instructions 250 may display an interface identifying a number of events and the intervals likely to contain events of interest. Visualization instructions 250 may include, for example, event timeline displaying instructions 252 and enlarged view displaying instructions 254. In addition to the details provided below in connection with FIG. 2, further details regarding an example visualization are provided in connection with FIG. 5.

Event timeline displaying instructions 252 may display an interface identifying a plurality of events over time. Timeline displaying instructions 252 may first display a plurality of cells, each corresponding to a particular interval of time. For example, displaying instructions 252 may output a grid of cells, where each cell represents one minute, five minutes, an hour, etc. The total number of cells displayed may be selected based on a total interval to be represented by the visualization. For example, if the total interval is one day, displaying instructions 252 may output a 6×4 grid of cells, where each cell represents a particular hour within the day. It should be noted that the total interval and the length of the interval represented by each cell may vary depending on the particular application and, in some embodiments, may be dynamically adjusted by a user of computing device 200.

In addition to displaying a cell for each interval of time to be displayed, timeline displaying instructions 252 may display a number of sub-cells within each cell, where each sub-cell is a smaller interval of time within the interval represented by the cell. To continue with the previous example, if the total interval is one day and each cell represents one hour, displaying instructions 252 may output a total of sixty sub-cells in each cell, where each sub-cell represents an interval of one minute.

The sub-cells within a given cell may be represented by a marker that is selected based on values of scores of events within the interval of time represented by the sub-cell. For example, the marker used for the sub-cell may be selected based on a total number of interesting events in the sub-interval compared to a total number of uninteresting events in the sub-interval. Thus, the marker may be a box with a first pattern or color when there are more interesting events, a box with a second pattern or color when there are more uninteresting events, and a box with a third pattern or color when there are an equal number of interesting and uninteresting events. As an alternative, the marker used for the sub-cell may represent the first event in the sub-interval, the last event in the sub-interval, or an average of event scores in the sub-interval.

Enlarged view displaying instructions 254 may display an enlarged view of a selected portion of the cells contained in the event timeline to aid the user in analysis of the intervals of time likely to contain events of interest. The area in the enlarged view may be automatically displayed to focus on the interval most likely to contain events of interest and, in some embodiments, may be dynamically shifted to a different portion based on input from the user. In contrast to the event timeline, which may use a marker to represent a plurality of individual events, the enlarged view may contain a cell for each event with a time within the selected portion of time. The cells may be color or pattern coded similarly to the markers, such that interesting and uninteresting events are visually distinguishable.

Furthermore, enlarged view displaying instructions 254 may add a visual feature to the enlarged view to distinguish each event in the enlarged view that is within a time interval likely to contain events of interest. For example, displaying instructions 254 may add a box or other shape around each cell that corresponds to an event in the interval. As another example, displaying instructions 254 may add a highlight, such as a yellow color, over each event cell within the interval of interest. In such implementations, a degree of transparency of the highlight may be proportional to the value of the calculated interestingness score for the interval. As an example, a high score for an interval may be represented by a high transparency, while a lower score for an interval may be represented by a lower transparency. Additional visual features for distinguishing events in an interval of interest will be apparent to those of skill in the art.

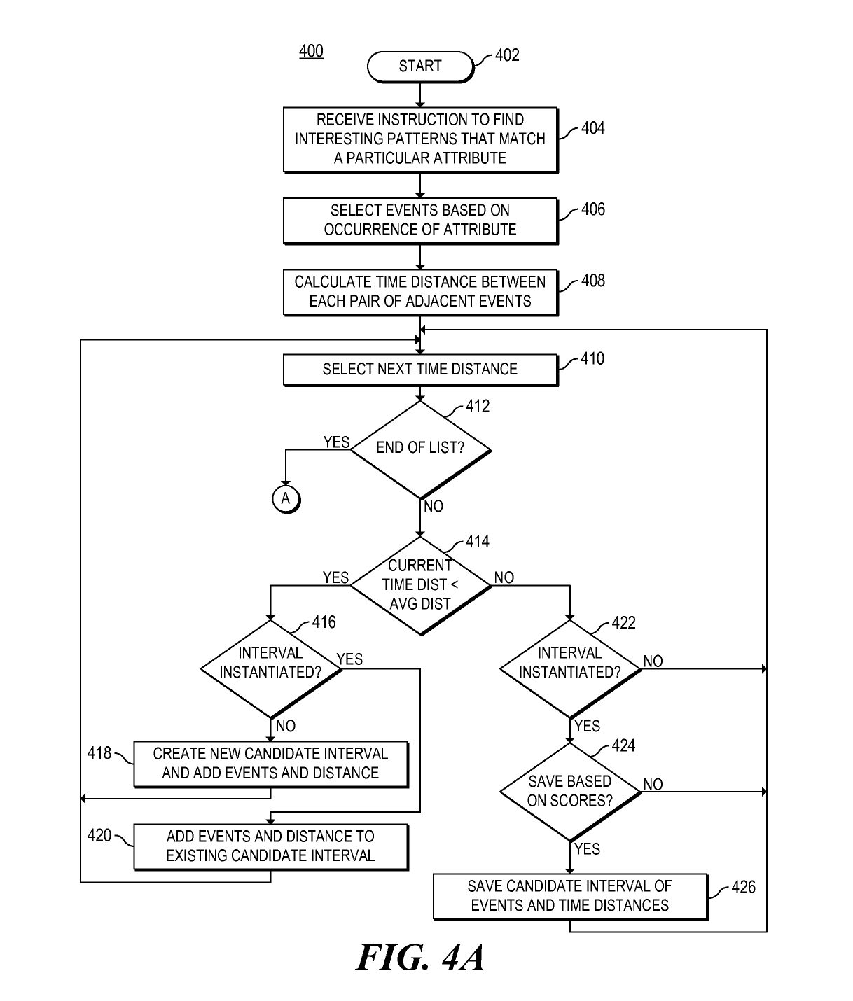

FIG. 3 is a flowchart of an example method 300 for identifying a time interval likely to contain events of interest. Although execution of method 300 is described below with reference to computing device 100, other suitable components for execution of method 300 will be apparent to those of skill in the art (e.g., computing device 200). Method 300 may be implemented in the form of executable instructions stored on a machine-readable storage medium, such as storage medium 120, and/or in the form of electronic circuitry.

Method 300 may start in block 305 and proceed to block 310, where computing device 100 may access a feed including a plurality of events, where each event is associated with a time and a score. The feed may be any source of information that includes a number of separate events (e.g., a review website, a message board, a social networking site, etc.), while each event is a data item corresponding to the particular type of feed (e.g., a review, a post, a status update, etc.). Computing device 100 may access the feed from any storage location, whether local or remote.

After computing device 100 accesses the feed, method 300 may proceed to block 315, where computing device 100 may calculate a score for each of a plurality of time intervals including at least one event. In some embodiments, the score of each time interval may be based on an interestingness of each event in the time interval, a density of interesting events in the time interval, and a smoothness of interesting events in the time interval.

As an example, the score for each interval of time may be the product of an interestingness, a time density, and a smoothness. The interestingness may be, for example, total number of interesting events in the time interval. The time density may be the product of a time density value and a fraction of interesting events in the time interval. Finally, the smoothness may be a standard deviation of time differences among pairs of consecutive time distance values in the time interval. Additional details regarding an example score calculation are provided above in connection with FIG. 1 and Equations 1-4.

After computing device 100 calculates a score for each time interval, method 300 may proceed to block 320. In block 320, computing device 100 may output a visualization identifying at least a portion of the plurality of events and a particular time interval with a score indicating that the particular time interval is likely to contain events of interest. For example, computing device 100 may output a grid or other configuration of cells, where each cell represents a fixed interval of time. Within each cell, computing device 100 may output a number of sub-cells, which may be color or pattern coded based on the number of interesting and uninteresting events in the interval represented by the sub-cell.

In some embodiments, computing device 100 may also display an enlarged view including a cell for each event with a time within a selected portion of time. The selected portion of time may be specified by a user or, alternatively, may be automatically identified to include the interval with a score indicating that the time is likely to contain events of interest. Within the enlarged view, computing device 100 may add a visual feature to distinguish each event for which the associated time is within the time interval likely to contain events of interest. For example, computing device 100 may add a box or other shape around each cell in the interval, highlight the cells in the interval, or otherwise distinguish the cells in the interval of interest from the other cells in the enlarged view. Additional details regarding an example visualization are provided above in connection with visualization instructions 250 of FIG. 2 and below in connection with visualization 500 of FIG. 5.

FIGS. 4A-4C, described in turn below, are methods that collectively identify a time interval likely to contain events of interest. Although methods 400, 430, 450 are described below with reference to computing device 200, other suitable components for execution of methods 400, 430, 450 will be apparent to those of skill in the art. Methods 400, 430, 450 may be implemented in the form of executable instructions stored on a machine-readable storage medium, such as storage medium 220, and/or in the form of electronic circuitry.

FIG. 4A is a flowchart of an example method 400 for grouping a plurality of events in a feed of events 227 into a plurality of candidate time intervals. Method 400 may start in block 402 and proceed to block 404, where computing device 200 may receive an instruction from a user to find interesting patterns that match a particular attribute. The user may specify, for example, a particular event feed 227, a period of time over which events should be analyzed, and one or more attributes that the events should match before being analyzed. In some embodiments, the user may also specify a condition indicating whether an event is to be considered interesting or uninteresting (e.g., a particular score or ranges of scores, a set of values for which the event is interesting, etc.).

After computing device 200 receives the instruction from the user, method 400 may proceed to block 406. In block 406, computing device 200 may select events from event feed 227 that match the attributes received in block 404. For example, computing device 200 may filter the event feed 227 to only select events that include one or more of the attributes. These attributes may be, for example, keywords, categories, customer feedback, sentimental values (e.g., like or dislike), or any other properties for which the user desires to filter the events.

Method 400 may then proceed to block 408, where computing device 200 may calculate a time distance between each pair of adjacent events. Computing device 200 may, for example, traverse the events in chronological order and, for each pair of events, determine an elapsed time between the two events. Based on execution of block 408, computing device 200 may generate a list of n−1 chronological time distances for a total of n events.

Method 400 may then proceed to block 410, where computing device 200 may select the next time distance in the list, which will be the first time distance in the first iteration. Method 400 may then proceed to block 412, where computing device 200 may determine whether it has reached the end of the list of time distances. If so, method 400 may trigger execution of method 430, described below in connection with FIG. 4B.

Alternatively, when computing device 200 determines in block 412 that it has not reached the end of the list, method 400 may proceed to block 414. In block 414, computing device 200 may determine whether the current time distance is less than the average time distance of all time distances. If so, method 400 may proceed to block 416, where computing device 200 may determine whether a candidate interval has been instantiated. If a candidate interval has not been instantiated, method 400 may proceed to block 418, where computing device 200 may create a new candidate interval object and add the current pair of adjacent events and the corresponding time distance. Otherwise, if a candidate interval has already been instantiated, method 400 may proceed to block 420, where computing device 200 may add the current pair of adjacent events and the corresponding time distance to the existing candidate interval. After execution of either block 418 or block 420, method 400 may return to block 410 for selection of the next time distance.

Alternatively, when computing device 200 determines in block 414 that the current time distance is greater than or equal to the average time distance, method 400 may proceed to block 422. In block 422, computing device 200 may determine whether an interval is currently instantiated. If not, method 400 may return to block 410 for selection of the next time distance.

Otherwise, if an interval is currently instantiated, method 400 may proceed to block 424, where computing device 200 may determine whether to save the candidate interval based on the scores of the events contained in the current candidate interval. For example, computing device 200 may determine whether the number of interesting events in the interval is greater than the number of uninteresting events and, if so, determine that the interval should be saved for further processing. Accordingly, method 400 may proceed to block 426, where computing device 200 may save the candidate interval and the events and time distances included therein. In subsequent iterations, after the candidate interval is saved, a new candidate interval will be instantiated when block 414 is satisfied. Method 400 may then return to block 410 for selection of the next time distance.

Otherwise, if computing device 200 determines that the interval should not be saved, method 400 may discard the candidate interval and therefore skip directly to block 410. Processing may continue in this manner until computing device 200 has processed all time distances.

FIG. 4B is a flowchart of an example method 430 for calculating a score for each of a plurality of candidate time intervals. Method 430 may start in block 432, where computing device 200 may determine whether there are remaining candidate intervals to be processed. If computing device 200 has processed all candidate intervals, method 430 may proceed to block 444, described in detail below. Otherwise, if there are remaining candidate intervals to be processed, method 430 may proceed to block 434, where computing device 200 may select the next candidate interval.

After selection of the next candidate interval, method 430 may proceed to block 436, where computing device 200 may calculate an interestingness value for the candidate interval, which may be, for example, a total number of interesting events in the time interval. Method 430 may then proceed to block 438, where computing device 200 may calculate a density value for the candidate interval, which may represent a compactness of interesting events in the time interval. Next, method 430 may proceed to block 440, where computing device 200 may calculate a smoothness value for the candidate interval, which may represent the regularity of interesting events over the time interval. Additional details regarding an example calculation of the interestingness, density, and smoothness values are provided above in connection with interestingness score assigning instructions 126 of FIG. 1 and Equations 2-4.

After determination of the three component values, method 430 may proceed to block 442, where computing device 430 may calculate the score for the candidate interval as the product of the interestingness value, the density value, and the smoothness value. Method 430 may then return to block 432 for selection of the next candidate interval.

After all candidate intervals have been processed, method 430 may proceed to block 444, where computing device 200 may generate a list of candidate intervals ranked by score. In this manner, by selecting the first n or last n elements (depending on the sorting order), computing device 200 may identify the n candidate intervals most likely to contain events of interest to the user. Computing device 200 may then trigger execution of method 450, described below in connection with FIG. 4C.

FIG. 4C is a flowchart of an example method 450 for outputting a visualization of a plurality of events and a time interval likely to contain events of interest. Method 450 may start in block 452, where computing device 200 may receive event data and candidate interval scores, such as the ranked list of candidate intervals generated in block 444 of FIG. 4B.

Method 450 may then proceed to block 454, where computing device 200 may determine the length of the time interval to be used for the cells and sub-cells of the visualization to be displayed. The length of a time interval represented by a cell may be a first interval of time, while the length represented by each sub-cell may be a smaller interval of time that divides the first interval into an integer number of sub-intervals. The length of these intervals may be preconfigured or, alternatively, may be specified by a user using a user interface element displayed by computing device 200.

After determination of the appropriate intervals, method 450 may proceed to block 456, where computing device 200 may select a marker for each sub-cell based on the scores included in the corresponding interval of time. For example, suppose a cell represents an hour, while each sub-cell represents a minute. In this case, computing device 200 may identify a marker for each of the sixty sub-cells. In selecting the marker, computing device 200 may, for example, assign one of three markers: a first marker when there are more interesting events in the interval (a minute in this case); a second marker when there are more uninteresting events; and a third marker when there are an equal number of interesting and uninteresting events. As an alternative, computing device 200 may determine the marker based on the score of the first event in the interval, the score of the last event in the interval, or an average of event scores in the interval.

Method 450 may then proceed to block 458, where computing device 200 may display a grid including the cells and, within each cell, include the marker selected for each of the plurality of sub-cells. Method 450 may next proceed to block 460, where computing device 200 may output an enlarged view for a selected portion of the cells. For example, computing device 200 may receive user input of a portion of the grid to be enlarged and display a separate cell for each event in the selected portion. In displaying these cells, computing device 200 may color or pattern code each cell based on whether the event is determined to be interesting or uninteresting.

Finally, method 450 may proceed to block 462, where computing device 200 may add a visual feature to the enlarged view to distinguish a candidate interval likely to contain events of interest to the user. For example, computing device 200 may add a box or other shape around each cell in the interval of interest, highlight the cells in the interval, or otherwise distinguish the cells in the interval from the other cells in the enlarged view. Method 450 may then proceed to block 464, where method 450 may stop.

FIG. 5 is an example visualization 500 of a plurality of events and a time interval likely to contain events of interest. As illustrated, visualization 500 may include a timeline 505 including a number of cells that occur in a total interval of three days identified by the date label 510. Furthermore, as indicated by the hour label 515, each cell in a particular day may represent a one hour interval between midnight (0:00) and 11:59 p.m. Within each cell of one hour, sixty sub-cells represent each minute and may be coded with markers according to legend 520.

Enlarged cell 525 illustrates an example cell, which represents the interval between 3:00 p.m. and 3:59 p.m. on August 10. As shown, enlarged cell 525 includes 26 minutes in which at least one event occurred and 34 minutes in which no event occurred. Each sub-cell corresponding to one of the 26 minutes in which at least one event occurred is labeled with a marker representing events during the corresponding minute. For example, in some embodiments, the marker may indicate whether the sub-cell includes more interesting events, more uninteresting events, or an equal number. In this example, the condition for determining interestingness of an event relates to negativity of the event's score. Accordingly, a striped marker represents an interval of time with more positive events, a dotted marker represents an interval with an equal number of positive and negative events, and a solid marker represents an interval with more negative events. As an alternative, the marker may instead represent, for example, the first event in the minute, the last event in the minute, or an average of scores of the events.

Enlarged view 535 illustrates a blown-up view of a selection portion 530 of the timeline 505. Selected portion 530 may correspond, for example, to a box selected by a user on timeline 505 using a mouse or other input mechanism. As illustrated, enlarged view 535 includes a number of rounded-rectangle cells, each corresponding to an event. The cells in the enlarged view 535 are coded with the same pattern as the markers used for the sub-cells in timeline 505. Thus, solid cell 540 corresponds to a negative event, while striped cell 545 corresponds to a positive event. In addition, enlarged view 535 includes a visual feature 550 that distinguishes the cells included in an interval of time likely to contain events of interest, which may be identified based on the interestingness score assigned to the interval.

Enlarged view 535 may also include scrolling interface elements 555, 560, which may allow a user to scroll in either direction to view additional cells in the enlarged view 535 that cannot be fit into a single window. Interface elements 555, 560 may be, for example, selectable arrows in a scroll bar, buttons, or any other elements suitable for receiving a user instruction to scroll enlarged view 535.

According to the foregoing, example embodiments disclosed herein analyze a feed of events to automatically identify one or more time intervals that are likely to contain events of interest. In this manner, example embodiments reliably isolate intervals of time that are likely to be of interest to an analyst, while significantly reducing the time and cost of analysis of the feed of events.

We claim:

1. A computing device for identifying, from a feed of events, a time interval likely to contain events of interest, the computing device comprising:
a processor to:
group a plurality of events from the feed into a plurality of time intervals based on a time associated with each event,
calculate a score for each time interval, wherein the score is based on an interestingness of each event in the time interval, a density of interesting events in the time interval, and a smoothness of interesting events in the time interval, and
select a particular time interval with a score indicating that the particular time interval is likely to contain events of interest.

2. The computing device of claim 1, wherein, prior to grouping the plurality of events, the processor is configured to:
select the plurality of events from the feed of events based on occurrence of a predetermined attribute in each selected event.

3. The computing device of claim 1, wherein, to group the plurality of events, the processor is configured to:
calculate a plurality of time distances, each time distance representing an elapsed time between a pair of consecutive events,
add a plurality of consecutive time distances to a candidate interval while each consecutive time distance is less than an average of the plurality of time distances, and
save the candidate interval when the candidate interval includes more interesting events than uninteresting events.

4. The computing device of claim 1, wherein, to calculate the score for each time interval, the processor is configured to determine the score as a product of:
a total number of interesting events in the time interval,
the density of interesting events, wherein the density is a product of a time density of all events in the time interval and a fraction of uninteresting events in the time interval, and
the smoothness of interesting events, wherein the smoothness is a standard deviation of time differences among pairs of consecutive time distance values in the time interval.

5. The computing device of claim 4, wherein, to select the particular time interval, the processor is configured to select the time interval for which the determined score is the largest.

6. The computing device of claim 1, wherein the processor is further configured to display a visualization of the feed of events, wherein the processor is configured to:
display a plurality of cells, each cell corresponding to a first interval of time,
display a marker for each of a plurality of sub-cells within each cell, wherein:
each sub-cell corresponds to a second interval of time within the first interval of time, and
the marker for each sub-cell is selected based on values of scores of events within the second fixed interval of time of the sub-cell.

7. The computing device of claim 6, wherein to display the visualization of the feed of events, the processor is further configured to:
display an enlarged view of a selected portion of the plurality of cells, the enlarged view containing an event cell for each event with a time within the selected portion, and
add a visual feature in the enlarged view to distinguish each event for which the associated time is within the particular time interval that is likely to contain events of interest.

8. The computing device of claim 1, wherein each event is an unstructured data item comprising text data.

9. A machine-readable storage medium encoded with instructions executable by a processor of a computing device to identify a time interval likely to contain events of interest, the machine-readable storage medium comprising:
instructions for accessing a feed comprising a plurality of events, wherein each event is associated with a time and a score;
instructions for grouping the plurality of events into a plurality of time intervals based on the time associated with each event;
instructions for assigning an interestingness score to each time interval based at least on the score of each event in the interval; and
instructions for selecting a particular time interval from the plurality of time intervals with an interestingness score indicating that the particular time interval is likely to contain events of interest.

10. The machine-readable storage medium of claim 9, wherein the instructions for accessing filter the feed to select events associated with a predetermined set of keywords.

11. The machine-readable storage medium of claim 9, wherein the instructions for assigning determine the interestingness score of each time interval based on:
an interestingness value representing a number of events in the time interval with scores that satisfy a predetermined condition,
a density value representing a compactness of events that meet the predetermined condition over the time interval, and
a smoothness value representing a regularity of events that meet the predetermined condition over the time interval.

12. The machine-readable storage medium of claim 11, wherein:
the instructions for assigning determine the interestingness score for each time interval to be a product of the interestingness value, the density value, and the smoothness value, and
the instructions for selecting select the particular time interval with a largest interestingness score.

13. A method for identifying a time interval likely to contain events of interest, the method comprising:
accessing a feed comprising a plurality of events, wherein each event is associated with a time and a score;
calculating a score for each of a plurality of time intervals comprising at least one event, wherein the score of each time interval is based on an interestingness of each event in the time interval, a density of interesting events in the time interval, and a smoothness of interesting events in the time interval; and
outputting a visualization identifying at least a portion of the plurality of events and a particular time interval with a score indicating that the particular time interval is likely to contain events of interest.

14. The method of claim 13, wherein the calculating comprises calculating the score as the product of:
a total number of interesting events in the time interval,
the density of interesting events, wherein the density is a product of a time density value of all events in the time interval and a fraction of uninteresting events in the time interval, and
the smoothness of interesting events, wherein the smoothness is a standard deviation of time differences among pairs of consecutive time distance values in the time interval.

15. The method of claim 13, wherein outputting the visualization comprises:
displaying a cell for each event with a time within a selected portion of time; and
adding a visual feature to distinguish each event for which the associated time is within the particular time interval that is likely to contain events of interest.
